(19) United States
(12) Patent Application Publication
(10) Pub. No.: US 2008/0047425 A1
(43) Pub. Date: Feb. 28, 2008

(54) Mission adaptable inlet particle separator

(75) Inventors: David C. Loda, Bolton, CT (US); James W. Norris, Lebanon, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/508,808

(22) Filed: Aug. 23, 2006

(51) Int. Cl. B01D 46/46

(52) U.S. Cl. 95/1; 96/417

(57) ABSTRACT

A gas turbine engine inlet particle separator system selectively engages and disengages an inlet particle separator from the engine in response to signals sensed by a sensor system or manually by the pilot. The controller system identifies a FOD-related flight regime to engage/disengage the inlet particle separator from the engine to provide increased engine power and fuel efficiency.

### BACKGROUND OF THE INVENTION

The present invention relates to aerospace vehicle systems and more particularly to a method and apparatus to selectively separate particles from an induced fluid within a rotary-wing aircraft to increase engine efficiency, aircraft range and lift capability.

It is desirable to prevent particles of dust and debris from entering the compressor of a gas turbine engine or similar turbomachine to minimize wear and the possibility of damage to compressor blades. The power loss associated with not using some separator system in a particulate environment may be significant and permanent due to compressor blade erosion.

Gas turbine engines in rotary-wing aircraft propulsion applications, for example, are typically protected against ingestion of airborne debris by inertial type inlet particle separators (IPSs). An IPS imparts a swirl effect on the inlet air to provide centrifugal separation of particles. Such separators mount on the engine upstream of the compressor entry and have flowpath defining walls which change the direction of the airflow through the separator to disassociate particles from the air to prevent foreign object damage (FOD).

Although conventional inlet particle separators are quite effective in the minimization of FOD, are self cleaning, and essentially maintenance free, the IPS is driven by engine power which reduces engine power and fuel efficiency. Furthermore, the IPS is linked to the engine such that the reduced efficiency occurs in flight regimes which during FOD may not be an issue.

Accordingly, it is desirable to provide an inlet particle separator which effectively minimizes FOD, yet increases engine efficiency, aircraft range and lift capability.

### SUMMARY OF THE INVENTION

The inlet particle separator system according to the present invention generally includes an inlet particle separator upstream of an engine, a particle separator drive system, a sensor system and a controller system. In operation, the controller system selectively engages and disengages the inlet particle separator from the engine in response to the sensor system which identifies a flight regime. One low FOD flight regime is cruise during which the aircraft is traveling at altitude and at a relatively high speed. During cruise, the controller system disengages the inlet particle separator from the engine to provide increased engine power and associated engine fuel efficiency. In addition, the particle separator system may be manually controlled by the pilot such that the inlet particle separator may be manually engaged and disengaged to override a pre-programmed FOD associated flight regime.

The present invention therefore provides an inlet particle separator which effectively minimizes FOD, yet increases engine efficiency, aircraft range and lift capability.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view an exemplary rotary wing aircraft embodiment for use with the present invention; and

FIG. 2 is a schematic block diagram of an inlet particle separator system.

### DETAILED DESCRIPTION OF THE PREFERRED EMBODIMENT

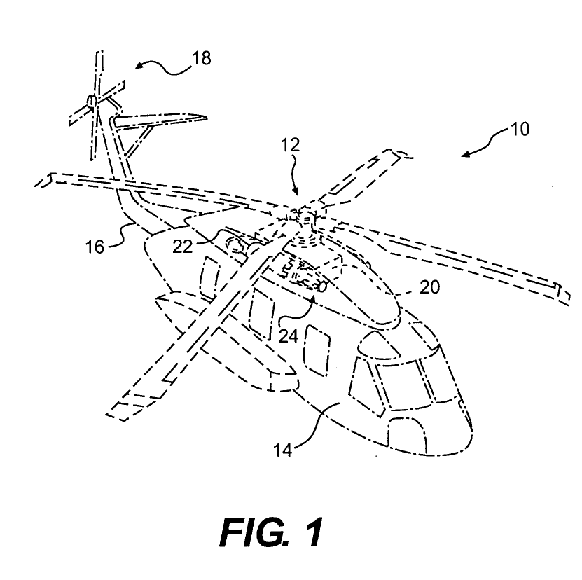

FIG. 1 schematically illustrates a rotary-wing aircraft 10 having a main rotor assembly 12. The aircraft 10 includes an airframe 14 having an extending tail 16 which mounts an anti-torque tail rotor system 18. The main rotor assembly 12 and the anti-torque tail rotor system 18 are driven through a transmission (illustrated schematically at 20) by one or more engines (illustrated schematically at 22). Although a particular helicopter configuration is illustrated in the disclosed embodiment, other Vertical Takeoff and Landing VTOL aircraft such as tilt-rotor, tilt-wing and aircraft with a STOL or hover capability, as well as turbine-powered ground vehicles such as military vehicles will also benefit from the present invention.

The engine 22 includes an inertial inlet particle separator system 24. The engine 22 compresses atmospheric air to elevate the air pressure, adds thermal energy, and exhausts the compressed high pressure air through a series of turbines. The turbines extract work from the high pressure air, which in turn, drives the transmission 20. Typically, air is induced into the engine 22 under ambient conditions and is exhausted from the engine 22 at ambient conditions. When air is induced at lower pressures than ambient the engine works harder to produce the same amount of power that is created at ambient pressures. This increase in work may result in increased fuel consumption. The system 24 selectively operates to separate induced fluid into a particulate contaminated fluid and clean fluid during various contamination conditions to minimize air pressure loss and minimize fuel consumption.

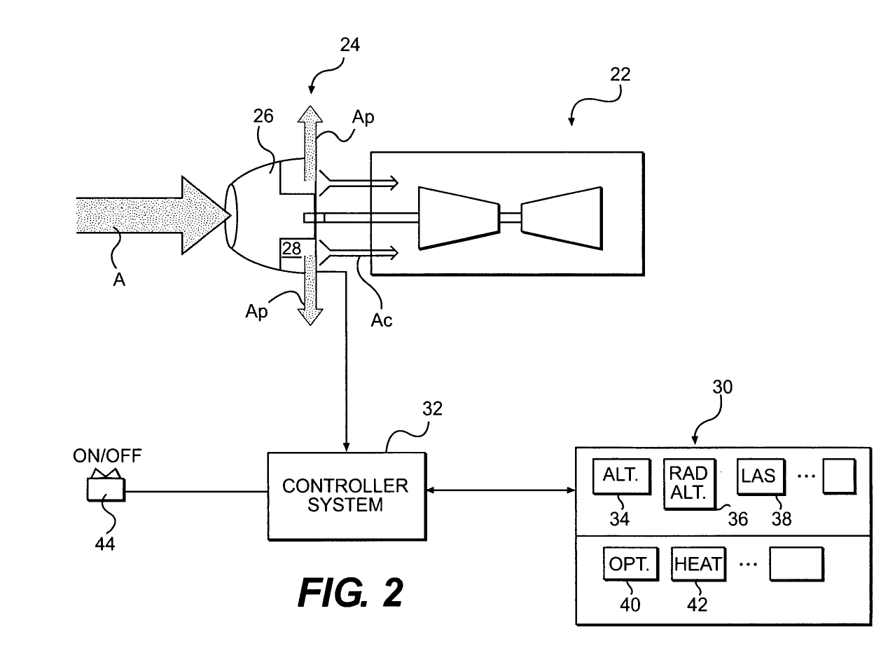

Referring to FIG. 2, the inlet particle separator system 24 generally includes an inlet particle separator 26 upstream of the engine 22, a particle separator drive system 28, a sensor system 30 and a controller system 32. Induced air, represented by arrow A, enters the separator 26 and is split into a particulate contaminated fluid Ap and a clean fluid Ac. The particulate contaminated fluid Ap is ejected and the clean fluid Ac is communicated to the engine 22. It should be understood that the inlet particle separator 26 may be of any driven, preferably inertia-type, particle separator.

The particle separator drive system 28 may take the form of any selectively driven system such as that the inlet particle separator 26 is selectively driven by the engine 22. that is, the particle separator drive system 28 may be a transmission-type system which selectively engages and disengages the inlet particle separator 26 from the engine 22. Alternatively, the particle separator drive system 28 may be a separate drive system which may take the form of an electric motor or bleed air (pneumatic) driven system which may likewise be selectively engaged and disengaged such that the inlet particle separator 26 may be driven independent of engine 22 operations.

The controller system 32 communicates with the particle separator drive system 28 and the sensor system 30. The controller system 32 may include a microprocessor based controller such as a computer having a central processing unit, memory (RAM and/or ROM), and associated input and output buses. The controller 32 may alternatively or additionally be a subsystem of a central vehicle main flight control unit, an engine control unit, an interactive vehicle dynamics module, or a stand-alone controller. The controller 32 may also be a solid-state digital or analog logic device.

The controller system 32 communicates with the sensor system 30 to selectively engage the particle separator drive system 28 in response to signals sensed by the sensor system 30. The sensor system 30 may include avionics such as an altimeter 34, a radar altimeter 36, and/or a laser velocimetry system 38. The sensor system 32 may alternatively or additionally include other dedicated “sand sniffer” type sensors including an optical device 40, a thermocouple type device 42 and or other particle sensing systems.

In operation, the controller system 32 selectively engages and disengages the inlet particle separator 26 from the engine 22 in response to signals sensed by the sensor system 30. Preferably, the controller system 32 identifies a FOD-related flight regime in which the likelihood of FOD damage may be determined. One low FOD flight regime is a cruise flight regime in which the aircraft is traveling at altitude and at a relatively high speed such as, for example only, above 200 feet of altitude AGL (above ground level) and at greater than 60 knots indicated airspeed. Thus, when a pre-programmed FOD-related flight regime condition is met, e.g., aircraft above 200 feet of altitude AGL (above ground level) and at greater than 60 knots indicated airspeed, the controller system 32 disengages the inlet particle separator 26 from the engine 22 to provide increased engine power and associated engine fuel efficient.

In addition, the particle separator drive system 28 may be manually controlled by the pilot through a cockpit switch 44 such that the inlet particle separator 26 may be manually engaged and disengaged. Examples of a low-FOD flight regime in which manual disengagement may be proper may be hovering over a low FOD surface such as water or tarmac. Moreover, disengagement of the inlet particle separator 26 in these conditions will provide increased engine power and the associated lift capacity. The need for gaining even a small fraction of additional power has been previously established, an example being the engine throttle “beep” thumb switches located on the pilot's collective control, which fine tunes the electronic engine control to gain as much power as possible during high demand flight regimes, such as an out-of-ground-effect hover. The cockpit switch control in this invention could alternatively or additionally be incorporated into or next to the “beep” switches to optimize pilot intuitive understanding of their use and function.

It should be understood that relative positional terms such as “forward,” “aft,” “upper,” “lower,” “above,” “below,” and the like are with reference to the normal operational attitude of the vehicle and should not be considered otherwise limiting.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An inlet particle separator system comprising:
a particle separator;
a sensor system; and
a control system in communication with said particle separator and said sensor system to selectively operate said particle separator in response to said sensor system.

2. The system as recited in claim 1, wherein said sensor system includes an altimeter.

3. The system as recited in claim 1, wherein said sensor system includes a radar altimeter.

4. The system as recited in claim 1, wherein said sensor system includes an airspeed indicator.

5. The system as recited in claim 1, wherein said sensor system includes a particulate sensor.

6. The system as recited in claim 1, wherein said sensor system includes an avionics system indicative of a FOD-related flight regime.

7. A method of separating particles from an induced fluid within a vehicle engine comprising the steps of:
(A) identifying a predefined condition; and
(B) selectively operating an inlet particle separator in response to said predefined condition.

8. A method as recited in claim 6, wherein said step (A) further comprises:
(a) identifying a high FOD flight regime.

9. A method as recited in claim 6, wherein said step (A) further comprises:
(a) identifying a low FOD flight regime.

10. A method as recited in claim 6, wherein said step (A) further comprises:
(a) identifying an altitude below a predetermined altitude.

11. A method as recited in claim 6, wherein said step (A) further comprises:
(a) identifying an airspeed below a predetermined airspeed.

12. A method as recited in claim 6, wherein said step (A) further comprises:
(a) identifying an altitude below a predetermined altitude; and
(b) identifying an airspeed below a predetermined airspeed.

13. A method as recited in claim 6, wherein said step (A) further comprises:
(a) identifying a particulate concentration in an induced airflow to the engine.

14. A method of separating particles from an induced fluid within an aircraft engine comprising the steps of:
(A) identifying an aircraft FOD-related flight regime; and
(B) selectively operating an inlet particle separator in response to the aircraft FOD-related flight regime.

15. A method as recited in claim 14, wherein said step (A) further comprises:
(a) identifying a high FOD flight regime.

16. A method as recited in claim 14, wherein said step (A) further comprises:
(a) identifying a low FOD flight regime.

17. A method as recited in claim 14, wherein said step (B) further comprises:
(a) selectively disengaging the inlet particle separator from an inlet particle drive system.

18. A method as recited in claim 14, wherein said step (B) further comprises:
(a) selectively engaging the inlet particle separator with an inlet particle drive system.

19. A method as recited in claim 18, wherein said step (a) further comprises:
(i) driving the inlet particle drive system with the engine.

20. A method as recited in claim 14, wherein said step (B) further comprises:
(a) manually operating the inlet particle separator with a pilot activatable switch.
